(19) United States
(12) Patent Application Publication
(10) Pub. No.: US 2012/0260591 A1
(43) Pub. Date: Oct. 18, 2012

(54) METHOD FOR PRODUCING PREFABRICATED COMPOUND TOWER-SEGMENT UNITS FOR A TOWER OF A WIND PLANT, AND FORMWORK UNIT FOR PRODUCING PREFABRICATED COMPOUND UNITS

(76) Inventors: Norbert Hölscher, Aurich (DE); Olaf Stracke, Emden (DE)

(21) Appl. No.: 13/501,969

(22) PCT Filed: Oct. 12, 2010
(86) PCT No.: PCT/EP2010/065284

§ 371 Date: Jul. 2, 2012

(30) Foreign Application Priority Data
Oct. 14, 2009 (DE) 10 2009 049 435.9

(51) Int. Cl. B28B 7/22; E04B 1/66; B28B 1/00; B28B 11/04; B28B 7/16; E02D 27/32

(52) U.S. Cl. 52/294; 249/204; 249/187.1; 264/35; 52/741.4

(57) ABSTRACT

There is provided a process for producing pylon segment precast concrete parts of a pylon of a wind power installation. A formwork is provided and the formwork is filled with concrete. A material of low viscosity is applied as an equalization layer to a flange of the precast concrete part.

### BACKGROUND

1. Technical Field

The present disclosure concerns a process for producing pylon segment precast concrete parts of a pylon of a wind power installation, a precast concrete part produced by the process, a formwork cover for fitting onto a formwork, a formwork unit for producing precast concrete parts and the use of a low-viscosity resin. Finally, the disclosure concerns a wind power installation.

2. Description of the Related Art

When constructing high towers or pylons, in particular for wind power installations, based on prefabricated concrete parts, it can happen, because of production tolerances, that the precast concrete parts which need to be placed one upon the other do not fit together in an optimum fashion. In concrete construction such tolerances are of an order of magnitude of ±10 mm.

Apart from the production tolerances which are felt in particular in relation to very high pylons or towers, generally the entire flange surface is required for carrying the load involved. However, because of unevenness (for example as a consequence of the production tolerances), the situation may involve the application of load being concentrated to some few surface portions which for example project beyond the rest of the flange, in the form of small raised areas. The concentration of the application of load to many excessively small surface portions almost inevitably results in damage there such as concrete spalling or chipping off, or the like. That damage goes as far as structural damage which involves replacement of the damaged segments, with all its economic and technical consequences. In that respect, mention will be made here of cranes for dismantling and reconstructing, operating personnel and a production outage of the wind power installation in question, which lasts for a correspondingly long time. Such a repair is particularly complicated and expensive in the case of pylons with tensioning wires which are pressed into casing tubes.

To avoid that problem, when constructing a precast concrete part pylon, before a segment is placed in position, an equalization layer can be applied to each flange of a precast concrete part, at the building site. That equalization layer must harden, which in turn, inter alia, requires compliance with minimum meteorological demands which are dependent on the material of the equalization layer. If those minimum demands are not met or if the equalization layer is incorrectly or negligently applied there is the risk of flaws or the risk of inadequate setting of the equalization layer.

As technological background reference is directed to DE 198 41 047 C1.

WO 2009/121581 A1 discloses a process for producing precast concrete parts. The concrete is cast into a casting mold having a planar floor for producing a planar underside. After the concrete has attained a predetermined minimum strength an equalization layer is applied to a join surface of the precast concrete part, which is opposite to the underside. As soon as the equalization layer has reached a predetermined minimum strength the precast concrete part is placed on an exactly horizontally oriented surface and the equalization layer on the top side is removed in plane-parallel relationship.

### BRIEF SUMMARY

Embodiments of the present invention provide a process for producing pylon segment precast concrete parts of a pylon of a wind power installation, which permits easier and faster erection of a pylon from the precast concrete parts, with a quality that remains consistently high.

There is provided a process for producing pylon segment precast concrete parts of a pylon of a wind power installation, in particular a pylon segment. In that case a material of low viscosity for an equalization layer is applied to a flange of the precast concrete part, which can optionally be effected as soon as the concrete has reached a predetermined minimum strength.

In that respect, some embodiments of the present invention are based on the realization that the operation of “mortaring” the joint on the building site during erection of the pylon can be shifted into the production factory building. In addition, it is possible to operate here with a tolerance of 0.1 mm, instead of the accuracy of about 10 mm, which is otherwise usual in concrete construction. This is more precise by the factor of 100. At the same time a higher level of process reliability is achieved by virtue of a markedly reduced susceptibility to flaws, for example when mixing the filler material, and also the health risks which are inherent when processing resins on the building site are avoided in that way.

In an aspect of the invention the thickness of the equalization layer is up to 10 mm, in particular up to 5 mm. Thus, even major unevenness in the region of the usual tolerances in concrete construction can also be compensated.

In a further aspect of the invention the formwork is closed by placing a formwork cover thereon and the material for the equalization layer is supplied under a predetermined pressure through at least one filling opening in the formwork cover. That makes it possible to provide a clearly defined cavity above the flange of the precast concrete part, which is filled with resin, so that an equally clearly defined equalization layer is formed.

In order to keep predetermined regions of the flange, for example openings for casing tubes or threaded bushes for abutment points, free of the equalization layer, predetermined regions of the flange are covered with seals of predetermined thickness prior to fitment of the formwork cover and those seals are held down by the formwork cover.

In accordance with the rules of structural engineering, the equalization layer is to have a modulus of elasticity corresponding to at least 70% of the modulus of elasticity of the concrete. It has surprisingly been found that the required mechanical properties of the equalization layer can be achieved even when the modulus of elasticity is in a range of 5,000 to 10,000 MPa if a predetermined layer thickness is not exceeded.

In order to be able to dissipate torsional forces which occur, without involving a relative movement of the precast concrete parts with respect to each other, a predetermined surface roughness is required. That should preferably be in a range of 60-150 μm.

Embodiments of the present invention also concern a formwork cover for fitting onto a formwork in the production of a precast concrete part. The formwork cover has an underside with at least one recess of a predetermined width in the radial direction of the cover, and a predetermined depth. The formwork cover also has at least one filling opening for introducing a material of an equalization layer.

To be able to reproducibly implement an exactly defined equalization layer the formwork cover includes a recess which is provided at the underside of the formwork cover, that faces towards the formwork, and which is of a predetermined width in the radial direction of the formwork cover and of a predetermined depth and having at least one filling opening for the material for the equalization layer.

In that respect, the width in the radial direction of the formwork cover can be such that it corresponds to the width of the flange on which the equalization layer is to be produced. The thickness of that equalization layer can also be exactly defined by the predetermined depth. As the formwork cover completely covers the upper opening of the formwork, at which the flange is provided, there can be at least one filling opening for the material of the equalization layer. To be able to see that a sufficient amount of material has been supplied through the filling opening, there is at least one outlet opening for the material of the equalization layer. When the material of the equalization layer issues from the formwork cover through the outlet opening, the material for the equalization layer is sufficiently distributed. In addition, the air displaced by the material flowing into the formwork cover can escape through the outlet opening so that voids or cavities (that is to say unwanted air inclusions in the material) can be reliably avoided because the air displaced by the material of the equalization layer can escape.

To avoid unnecessary fouling of the formwork cover, the formwork and also the surrounding area, the filling opening and/or the outlet opening are in the form of connecting portions for a hose. Accordingly hoses can be connected there and the material for the equalization layer can be cleanly supplied and discharged through the hoses.

In some embodiments, the formwork cover has side walls which stand (perpendicularly) on the top side, and a cover plate connecting the side walls. The box shape provided in that way imparts to the formwork cover a higher level of flexural stiffness and thus a higher degree of accuracy in shape.

In a particularly preferred development, stiffening means or devices which still further increase the flexural stiffness and thus the stability in respect of shape are arranged substantially parallel to the side walls between the top side of the formwork cover and the underside of the cover plate.

Embodiments of the present invention also concern a seal for use with an above-described formwork cover. The seal involves a two-part configuration with a deformable part and a non-deformable part. The deformable part is arranged on a location, that is to be sealed off, of the precast concrete part and the non-deformable part is placed on the deformable part in order thus to achieve a predeterminable height.

The seal can prevent regions of the flange which must remain free for given reasons from being covered by the equalization layer. Thus, the formwork cover can hold down the seal and can reliably press it against the concrete in such a way that the low-viscosity material for the equalization layer cannot flow in there.

In another particularly preferred embodiment a development of the seal is such that the deformable part is of a ring-shaped configuration and is provided with a contact surface of predetermined width, on which the non-deformable part rests. That embodiment permits the use of seals which are used in any case in relation to the precast concrete parts for sealing off the casing tubes in the transitions between the precast concrete parts, when applying the equalization layer.

Embodiments of the present invention also concern a formwork unit for producing a precast concrete part. The formwork unit has a formwork for receiving concrete, an above-described formwork cover and an above-described seal.

Embodiments of the present invention also concern the use of a low-viscosity resin for producing an equalization layer in the production of a precast concrete part, wherein the resin is applied to the flange of a precast concrete part. In that way an equalization layer which can replace the production of a mortar joint on the building site can already be produced in the factory under controlled conditions in production of the precast concrete part.

In addition the wind power installation concerns a pylon comprising a plurality of precast concrete parts which are or can be produced in accordance with the process of embodiments of the present invention. The construction of such a pylon is simple and quick to implement, irrespective of the weather, and thus allows the erection of a wind power installation in a very short time while eliminating possible sources of error. At the same time, this gives a reduction in cost due to fewer crane times being required because the individual assembly steps take up less time and the crane is thus more quickly available again for other jobs.

According to embodiments of the present invention, it is possible to avoid applying resin mortar as the equalization layer, on the building site. That is advantageous as the resins or resin mortars used are known to be allergy-triggering substances and thus possibly adversely affect the health of the people dealing with such resins. Resin can now be used instead of resin mortar.

Further embodiments of the invention are subject-matter of the appendant claims.

### BRIEF DESCRIPTION OF THE SEVERAL VIEWS OF THE DRAWINGS

Advantages and embodiments by way of example of the invention are described in greater detail hereinafter with reference to the Figures.

FIG. 1 shows a flow chart of a process for producing precast concrete parts in one embodiment.

FIG. 2 shows a diagrammatic sectional view of a pylon segment precast concrete part in the production in accordance with one embodiment.

FIG. 3 shows a perspective view of a formwork cover according to one embodiment.

FIG. 4 shows the use of the formwork cover with a seal, according to one embodiment.

FIG. 5 shows the use of the seal in another embodiment.

### DETAILED DESCRIPTION

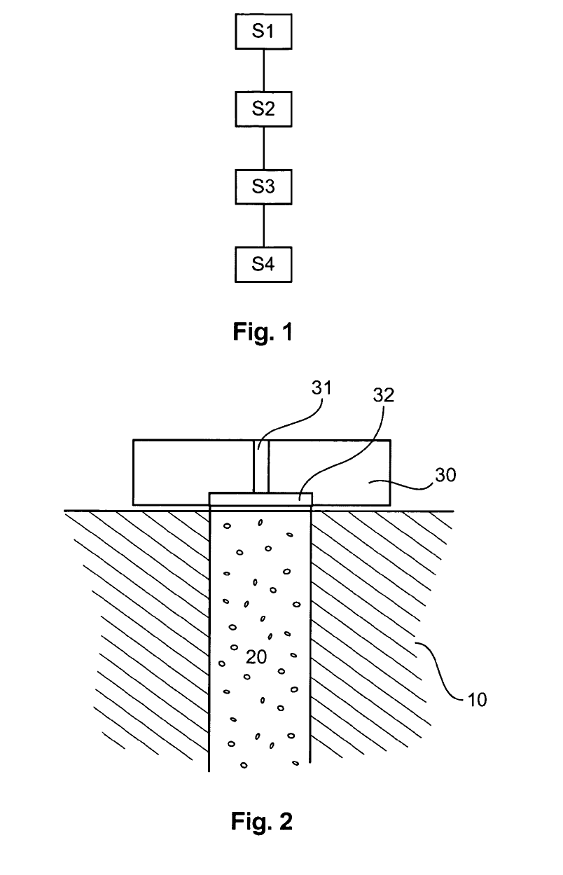

FIG. 1 shows a flow chart of a process for producing precast concrete parts according to one embodiment. The precast concrete parts are pylon segments of a pylon of a wind power installation. For that purpose, firstly a formwork or form for the precast concrete part is provided in step S1. Step S2 involves filling the formwork with concrete. In step S3 the concrete has attained a predetermined minimum strength or concrete has been abraded away and in step S4 a low-viscosity resin is applied in the region of the flange of the precast concrete part and then hardens there in situ. The operation of introducing the resin as the material for the equalization layer can be effected about two hours after the step S2 of introducing the concrete into the formwork. In that case, the resin is pressed into the formwork at about 31/minute and that operation lasts about 3 to 10 minutes depending on the respective size of the formwork and the volume resulting therefrom.

By virtue of the low viscosity of the resin, the resin can be well spread out on the flange of the precast concrete part and on the one hand can thus equalize any unevenness present in the precast concrete part while on the other hand it can form an exactly horizontal surface because it is (exactly) leveled itself by virtue of the low viscosity. On the assumption that the opposite flange is also exactly horizontally oriented and is flat, both flanges are then precisely in plane-parallel relationship.

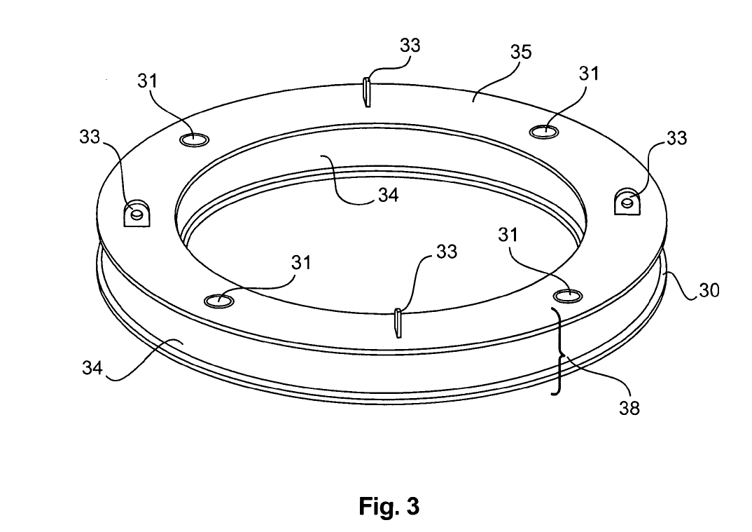

FIG. 2 shows a diagrammatic sectional view of a precast concrete part 20 in production in accordance with one embodiment. The precast concrete parts 20 are pylon segments of a pylon of a wind power installation. Production of the precast concrete part 20 in accordance with this embodiment can substantially correspond to production of the precast concrete part 20 in the embodiment described above. Thus, concrete is introduced into an existing formwork 10. Provided in the region of the flange of the precast concrete part 20 is a formwork cover 30 having a filling opening 31 and a recess 32. In this case the recess 32 is provided at the underside of the formwork cover 30 and is disposed above the flange of the precast concrete part 20, by the formwork cover 30 being placed on the formwork 10.

After the formwork cover 30 has been placed on the formwork, 10 a low-viscosity resin is introduced into the recess 32 through the filling opening 31. By virtue of the low viscosity of the resin, the resin can readily spread out along the flange of the precast concrete part 20 and in so doing also equalizes any unevenness present. In addition, by virtue of its low viscosity, the resin forms a surface which is horizontally leveled and—presupposing a horizontally extending underside of the precast concrete parts—a surface which is in plane-parallel relationship therewith. Preferably the equalization layer comprising the low-viscosity resin is of a thickness of a maximum of 10 mm and particularly preferably not more than 3 or 4 mm. With such a layer thickness the equalization layer has advantageous mechanical properties which also allow the use of a material with a relatively low modulus of elasticity in the range of 5,000 to 10,000 MPa.

If the equalization layer is excessively thick it can be pressed laterally out of the join by the weight of the load resting thereon. As there is a connection between the equalization layer and the concrete, corresponding forces act on the concrete. As this involves tensile stresses transversely relative to the vertical axis of the pylon, those stresses are referred to as transverse tensile stresses. Such transverse tensile stresses are problematical in relation to concrete because it enjoys relatively high compression strength but only relatively low tensile strength. It will be noted however that with a layer thickness of a maximum of 4 mm, transverse tensile stresses acting on the concrete are not to be feared.

The resin is introduced into the formwork cover 30 about two hours after casting of the concrete in the formwork 10. Then the concrete on the one hand has reached a predetermined minimum strength but on the other hand it has not yet completely set so that the resin can still bind to the concrete. After about three to four hours the precast concrete part 20 and the resin have reached a sufficient strength and the formwork 10 can be removed.

FIG. 3 shows a perspective view of a formwork cover 30 according to one embodiment of the present invention. The formwork cover 30 is of a ring-shaped configuration. Side walls 34 which are fitted onto the formwork cover 30 and a cover plate 35 arranged on the side walls 34 provide a box-shaped structure which in its entirety is referred to as a formwork box 38. Fixing eyes 33 are optionally arranged on the cover plate 35, with which the formwork box 38 can be handled using load lifting devices.

In addition, openings 31 are provided in the cover plate 35, which pass through the formwork box 38 and can represent filling openings and outlet openings for the material of the equalization layer so that that material can be introduced into the formwork (not shown in this Figure) through the formwork box 38 when fitted thereon.

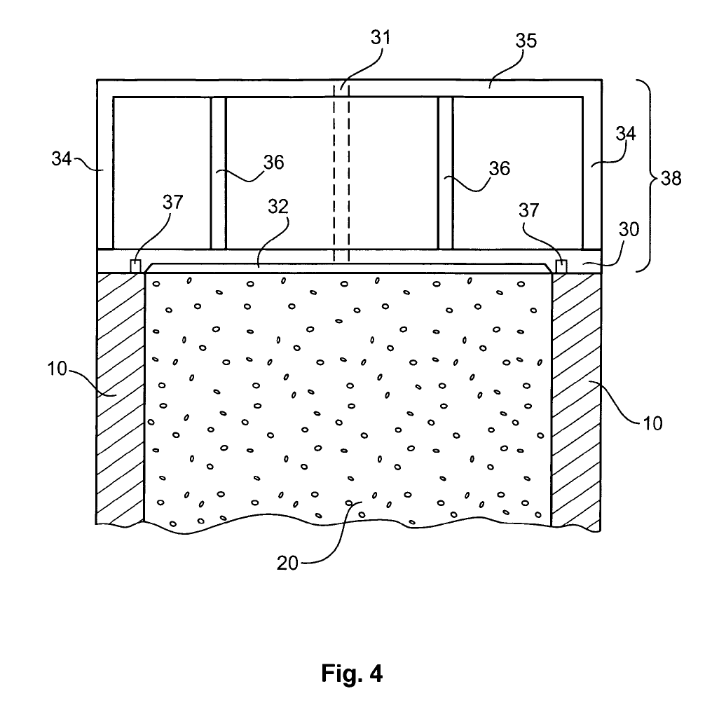

FIG. 4 shows a use of the formwork cover 30 with a seal in accordance with one embodiment. FIG. 4 shows a formwork 10 with concrete 20 which has already been introduced thereinto. The concrete 20 or the precast concrete part 20 terminates flush with the upper edge of the formwork 10. The formwork box 38 according to this embodiment of the invention is fitted onto the formwork 10. It is of a box-shaped cross-section formed from a formwork cover 30 and two side walls 34 and a cover plate 35 connecting the side walls 34, to improve flexural stiffness and thus accuracy in respect of shape. Further stiffening means or devices 36 can optionally be provided, for still further increasing flexural stiffness.

At its underside (towards the formwork 10) the formwork cover 30 has a recess 32. The recess 32 extends in the radial direction over a predetermined width which as can be clearly seen corresponds to the internal width of the formwork 10 and thus the width of the precast concrete part 20. Provided at both sides of that recess 32 are recesses 37 as optional seal seats to provide for reliably sealing off the formwork cover 30 or the formwork box 38 in relation to the formwork 10.

The recess 32 at the underside of the formwork cover 30 is of a predetermined height which optionally (precisely) corresponds to the intended height of the equalization layer (not shown in this Figure). The material for the equalization layer can be introduced from the exterior into the recess 32 of the formwork cover 30 through a filling opening 31 which extends between the formwork cover 30 and the cover plate 35 and which is shown in broken line in FIG. 4, and can thus completely fill the cavity formed by the recess 32.

It can be clearly seen from FIG. 3 that the formwork cover 30 according to one embodiment of the invention has four such openings 31 of which for example two can be used as filling openings and two can be used as outlet openings. As soon as the entire recess 32 of the formwork cover 30 is filled, when further material is supplied thereto, that material can issue again through the outlet openings and can thus clearly perceptibly indicate that the recess 32 is now completely filled with material. If that material is now left to set, an equalization layer is formed, which is fixedly joined to the precast concrete part 20.

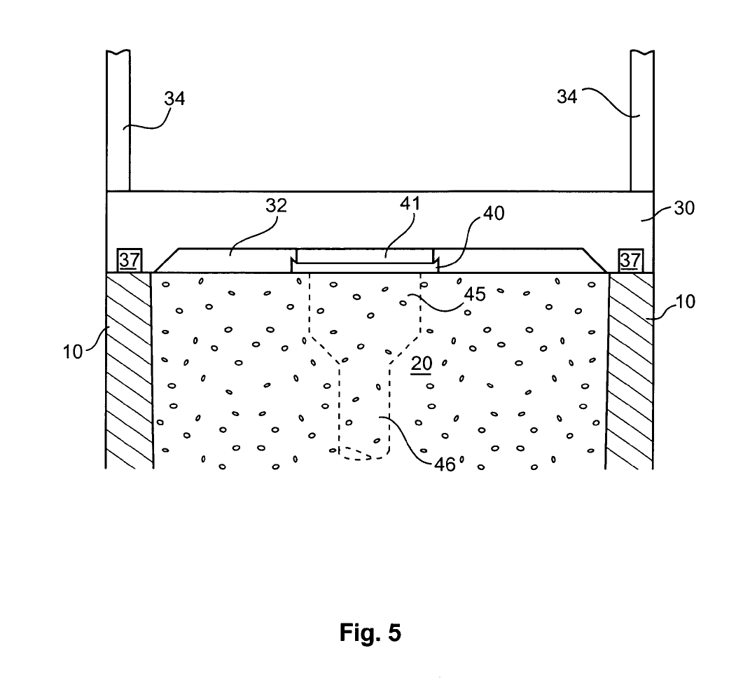

FIG. 5 shows a use of a seal in accordance with another embodiment. In particular, FIG. 5 shows a view on an enlarged scale of the formwork 10 with the precast concrete part 20 and the formwork cover 30 fitted thereon, with indicated side walls 34 and the seal seat 37. The recess 32 is shown on a markedly enlarged scale, at the underside of the formwork cover 30, that is towards the formwork 10. It is firstly to be noted that the recess 32 is not exactly right-angled but narrows upwardly from the formwork 10 and is therefore of a trapezoidal configuration. That gives an equalization layer with beveled side edges.

Shown approximately at the center of the recess 32 is a seal according to one embodiment of the invention, formed from a first deformable part 40 and a second non-deformable part 41. The deformable part 40 is placed on the region of the precast concrete part 20 that is not to be covered by the equalization layer. This Figure shows by way of example in broken line a casing tube 46 having a casing tube funnel portion 45, in which the tensioning wires later run and which therefore must remain free of obstructions. It will be appreciated that in this case two fixing points (not shown in this Figure) for load lifting devices for handling the precast concrete part 20 or other predetermined locations on the surface of the precast concrete part 20 can be covered over.

For that purpose, firstly the first deformable part 40 is placed on the location to be covered over and then the second non-deformable part 41 is placed thereon. As the two sealing parts 40, 41 are of a predetermined thickness, that also gives overall a predetermined height which is somewhat greater than the depth of the recess 32 in the formwork cover 30. The upper non-deformable part 41 of the seal is pressed onto the lower deformable part 40 by virtue of the formwork cover 30 being fitted in place so that the seal 40, 41 is held down by the formwork cover 30 and pressed against the surface of the precast concrete part 20. In that way, the part covered by the seal 40, 41, of the surface of the precast concrete part 20 is kept free of the equalization layer.

It is to be noted that the filling and outlet openings 31 are not placed over a seal 40, 41 for that opening 31 is naturally also closed by the seal 40, 41 which is held down by the formwork cover 30 or the formwork box 38, so that introduction of the material and/or venting of the recess 32 is at least impeded, if not even entirely prevented.

If the above-described formwork cover 30 is used, leveling of the resin can then be achieved by the resin being introduced into the formwork 10 through the openings provided for that purpose, until it is pressed against the formwork cover 30.

Embodiments of the present invention also concern a formwork unit for producing a precast concrete part 20. The formwork unit has a formwork 10 and a formwork cover 30, for example, as shown in FIG. 3. Seals 40,41 can optionally also be provided.

Embodiments of the present invention also concern a wind power installation having a pylon which is made up of precast concrete parts 20 or pylon segments which have been produced in accordance with embodiments of the present invention described above.

In accordance with a further embodiment of the invention which can be based on one of the above-described embodiments, a dry join is used between pylon segments which rest one upon the other. For that purpose it is possible to dispense with a further joint adhesive. In addition, for that purpose it is possible to dispense with a further equalization layer.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A process for producing a pylon segment precast concrete part of a pylon of a wind power installation having at least one flange, comprising:
providing a formwork;
filling the formwork with concrete; and
applying a material of low viscosity as an equalization layer to the flange of the precast concrete part.

2. A process according to claim 1, further comprising:
closing the formwork by placing a formwork cover thereon; and
supplying the material for the equalization layer at a predetermined pressure through at least one filling opening in the formwork cover.

3. A process according to claim 1, further comprising the steps:
covering predetermined regions of the flange prior to fitting a formwork cover with seals of predetermined thickness; and
holding down said seals with the formwork cover.

4. A pylon segment precast concrete part produced by a process according to claim 1.

5. A precast concrete part according to claim 4 wherein the concrete has a modulus of elasticity of between 25,000 and 50,000 MPa and the equalization layer has a modulus of elasticity of between 5,000 and 10,000 MPa.

6. A precast concrete part according to claim 4 wherein the precast concrete part has a predetermined surface roughness, between 60 to 150 μm.

7. A formwork cover for fitting onto a formwork for producing a pylon segment precast concrete part of a pylon of a wind power installation, the formwork cover comprising:
an underside having at least one recess which is of a predetermined width in the radial direction of the formwork cover and a predetermined depth; and
at least one filling opening for introducing a material of an equalization layer.

8. A formwork cover according to claim 7, and further comprising:
at least one outlet opening for the material of the equalization layer.

9. A formwork cover according to claim 7 wherein the filling opening is in the form of a connecting portion for a hose.

10. A formwork cover according to claim 7, further comprising:
an annular cover plate; and
side walls provided at the cover plate.

11. A formwork unit for producing a pylon segment precast concrete part of a pylon of a wind power installation, the formwork unit comprising:
a formwork for receiving concrete;
a formwork cover having an underside with at least one recess of a predetermined width in the radial direction of the formwork cover and a predetermined depth and having at least one filling opening for introducing a material of an equalization layer;
a seal having a deformable part and a non-deformable part of respectively predetermined thickness, the deformable part can configured to be arranged on a location, that is to be sealed, of the precast concrete part and the non-deformable part configured to be placed on the deformable part to attain a predeterminable height.

12. A formwork unit according to claim 11 wherein the deformable part of the seal is in the form of an annularly deformable part having a contact surface of predetermined width, on which the non-deformable part rests.

13. A method comprising:
providing a low-viscosity resin for producing an equalization layer in the production of a pylon segment precast concrete part of a pylon of a wind power installation; and
applying the resin to a flange of the precast concrete part.

14. A wind power installation having a pylon comprising a plurality of precast concrete parts which are produced in accordance with a process according to claim 1.
